(19) United States
(12) Patent Application Publication
(10) Pub. No.: US 2003/0016744 A1
(43) Pub. Date: Jan. 23, 2003

(54) Data processing device, data processing method, computer readable recording medium, and data processing program to prevent illegal reproduction of information data

(75) Inventor: Toshiyuki Nakagawa, Kanagawa (JP)

Correspondence Address: HOGAN & HARTSON L.L.P., 500 S. GRAND AVENUE, SUITE 1900, LOS ANGELES, CA, 90071-2611, US

(73) Assignee: CANON KABUSHIKI KAISHA

(21) Appl. No.: 10/187,565

(22) Filed: Jul. 1, 2002

(30) Foreign Application Priority Data
Jul. 4, 2001 (JP) 203385/2001
Jul. 4, 2001 (JP) 203386/2001

(51) Int. Cl. H04B 1/66; H04N 7/12; H04N 11/02; H04N 11/04

(52) U.S. Cl. 375/240.01; 375/240.12

(57) ABSTRACT

A data processing apparatus receives a bit stream containing one or a plurality of encoded object data for objects and managing information that manages the object data, and decodes the encoded object data by each of the objects. The data processing apparatus includes an extraction section that extracts a first region code indicative of a region with respect to the object data included in the managing information, an acquisition section that acquires a second region code indicative of a region with respect to the data processing apparatus, and a control section that controls a reproduction process for the object data according to the first region code and the second region code.

### BACKGROUND OF THE INVENTION

1. Field of the Invention

The present invention relates to a data processing device, a data processing method, a computer readable recording medium, and a data processing program, and in particular to data processing to prevent illegal copies of information data (to protect intellectual properties, for example, copyrights).

2. Description of Related Art

Presently, it is becoming a standard to encode as a single bit-stream by combining multi-media data containing multiple objects such as moving pictures and sounds in the ISO/IEC 14496 part 1 (Moving Picture Experts Group) MPEG-4 systems). At the receiving side (i.e., replaying side) of a MPEG-4 reproducing device, for example, sound and moving picture scenes are associated and then replayed. In the MPEG-4 reproducing device, various use restrictions need to be implemented with respect to all or part of the data to protect its copyright, etc.

The MPEG-4 data-stream noted above, unlike the conventional commonly used multi-media data stream, has a function to receive/send many video scenes and video objects independently in a single stream. Also, as for the sound data likewise, it is possible to reproduce many objects from a single stream. In other words, the MPEG-4 data-stream contains, in addition to the conventional video and audio data, Binary Format For Scenes (BIFS) in which the Virtual Reality Modeling Language (VRML) is expanded to handle natural moving pictures and sounds as information to define spatial and chronological dispositions of each object. It is noted that the BIFS is information which describes MPEG-4 scenes with binary values.

Since each individual object required to reproduce the scenes as noted above is sent after being optimally encoded individually, it is decoded individually on the decoding side. The time axis of each datum is synchronized with the time axis of the reproduction device according to the descriptions of the BIFS noted above to reproduce the scenes.

Since the MPEG-4 reproduction device mixes multiple objects, the use of each of the objects needs to be restricted by their intellectual property right. Therefore, a system may be required to obtain information that verifies the use of the intellectual property for each object.

Generally, as an example to restrict the reproduction of multi-media data by region, region codes that are assigned to six divided regions in the world to protect the copyright are set up, for example, for DVD apparatuses. These regions codes are matched against codes retained in DVD-Videos and DVD-Video replay apparatuses, and are used to control, by each region, if the DVD-Videos can be reproduced.

Although it is possible to control the reproduction by region for the entire multi-media data distributed via networks or recording media such as CD-ROMs, no method has been proposed to control the reproduction by region for specific objects in multi-media data such as a MPEG-4 bit-stream consisting of multiple objects.

Also, as for specific objects which are determined not to be used by the verification information or objects for which proper fees for the use of their copyright have not been paid, no method has been proposed to protect the data (to protect their intellectual properties), for example, by switching to another object and then replaying.

In addition, there has been no method proposed which allows the transmission side to set up positions (e.g., timings) to implement the reproduction control against object data to protect the data.

### SUMMARY OF THE INVENTION

The present invention provides a data processing device, a data processing method and a data processing program, which control the reproduction of data by region for each object data when reproducing the data from a data stream containing encoded single or multiple object data, and a computer readable recording medium that stores the data processing program.

A preferred embodiment of the present invention pertains to a data processing apparatus that receives a bit stream containing one or a plurality of encoded object data for objects and managing information that manages the object data, and decodes the encoded object data by each of the objects, The data processing apparatus may include an extraction device that extracts a first region code indicative of a region with respect to the object data included in the managing information, an acquisition device that acquires a second region code indicative of a region with respect to the data processing apparatus, and a control device that controls a reproduction process for the object data according to the first region code and the second region code.

A preferred embodiment of the present invention pertains to a data processing method that receives a bit stream containing one or a plurality of encoded object data for objects and managing information that manages the object data, and decodes the encoded object data by each of the objects. The data processing method may include the steps of extracting a first region code indicative of a region with respect to the object data included in the managing information, acquiring a second region code indicative of a region with respect to the data processing apparatus, and controlling a reproduction process for the object data according to the first region code and the second region code.

A computer-readable recording medium, in accordance with a preferred embodiment of the present invention, stores program codes to achieve functions of a data processing apparatus that receives a bit stream containing one or a plurality of encoded object data for objects and managing information that manages the object data, and decodes the encoded object data by each of the objects. The program codes may include codes for an extraction step for extracting a first region code indicative of a region with respect to the object data included in the managing information, codes for an acquisition step for acquiring a second region code indicative of a region with respect to the data processing apparatus, and codes for a controlling step for controlling a reproduction process for the object data according to the first region code and the second region code.

A data processing program, in accordance with a preferred embodiment of the present invention, includes steps to achieve functions of a data processing apparatus that receives a bit stream containing one or a plurality of encoded object data for objects and managing information that manages the object data, and decodes the encoded object data by each of the objects. The data processing program may include an extraction step for extracting a first region code indicative of a region with respect to the object data included in the managing information, an acquisition step for acquiring a second region code indicative of a region with respect to the data processing apparatus, and a controlling step for controlling a reproduction process for the object data according to the first region code and the second region code.

Also, in accordance with other embodiments of the present invention, there are provided a data processing apparatus, a data processing method, a computer-readable recording media that stores a data processing program, and a data processing program, which is capable of executing, when reproducing object data from a bit stream containing single or multiple encoded object data, a data reproduction control for desired object data from the supply side of the data stream based on determinations made as to whether or not a reproduction of the object data is permitted.

A preferred embodiment of the present invention pertains to a data processing apparatus that receives a bit stream containing one or a plurality of encoded object data for objects and managing information that manages the object data, and decodes the encoded object data by each of the objects. The data processing apparatus may includes a determination device that makes a determination as to whether or not a reproduction of the object data is permitted based on the managing information, an extraction device that extracts event information from the managing information for changing the object data to another data, and a control device that controls a reproduction process for the object data according to an output of the determination device and the event information.

A preferred embodiment of the present invention pertains to a data processing method that receives a bit stream containing one or a plurality of encoded object data for objects and managing information that manages the object data, and decodes the encoded object data by each of the objects. The data processing method may includes the steps of making a determination as to whether or not a reproduction of the object data is permitted based on the managing information, extracting event information from the managing information for changing the object data to another data, and controlling a reproduction process for the object data according to an output of the determination device and the event information.

A preferred embodiment of the present invention pertains to a computer-readable recording medium that stores program codes to achieve functions of a data processing apparatus that receives a bit stream containing one or a plurality of encoded object data for objects and managing information that manages the object data, and decodes the encoded object data by each of the objects. The program codes may include codes for a determination step for making a determination as to whether or not a reproduction of the object data is permitted based on the managing information, codes for an extraction step for extracting event information, from the managing information, for changing the object data to another data, and codes for a control step for controlling a reproduction process for the object data according to an output of the determination device and the event information.

A preferred embodiment of the present invention pertains to a data processing program comprising steps to achieve functions of a data processing apparatus that receives a bit stream containing one or a plurality of encoded object data for objects and managing information that manages the object data, and decodes the encoded object data by each of the objects, The data processing program may include a determination step for making a determination as to whether or not a reproduction of the object data is permitted based on the managing information, an extraction step for extracting event information, from the managing information, for changing the object data to another data, and a control step for controlling the reproduction process for the object data according to an output of the determination device and the event information.

A preferred embodiment of the present invention pertains to a data processing apparatus that receives a bit stream containing one or a plurality of encoded object data for objects and managing information that manages the object data, and decodes the encoded object data by each of the objects. The data processing apparatus may include a determination device that makes a determination as to whether or not a reproduction of the object data is permitted based on the managing information, an extraction device that extracts event information, from the managing information, for changing the object data to another data, and a control device that controls a reproduction process for the object data according to an output of the determination device and the access point information.

A preferred embodiment of the present invention pertains to a data processing method that receives a bit stream containing one or a plurality of encoded object data for objects and managing information that manages the object data, and decodes the encoded object data by each of the objects. The data processing method may include the steps of making a determination as to whether or not a reproduction of the object data is permitted based on the managing information, extracting access point information from the managing information, the access point information being indicative of at least one position at which the reproduction process is controlled, and controlling a reproduction process for the object data according to a determination result in the step of making a determination and the access point information.

A preferred embodiment of the present invention pertains to a computer-readable recording medium that stores program codes to achieve functions of a data processing apparatus that receives a bit stream containing one or a plurality of encoded object data for objects and managing information that manages the object data, and decodes the encoded object data by each of the objects. The program codes may includes codes for a determination step for making a determination as to whether or not a reproduction of the object data is permitted based on the managing information, codes for an extraction step for extracting access point information from the managing information, the access point information indicative of at least one position at which the reproduction process is controlled, and codes for a control step for controlling a reproduction process for the object data according to a determination result in the step of making a determination and the access point information.

A preferred embodiment of the present invention pertains to a data processing program comprising steps to achieve functions of a data processing apparatus that receives a bit stream containing one or a plurality of encoded object data for objects and managing information that manages the object data, and decodes the encoded object data by each of the objects. The data processing program may include a determination step for making a determination as to whether or not a reproduction of the object data is permitted based on the managing information, an extraction step for extracting access point information from the managing information, the access point information indicative of at least one position at which the reproduction process is controlled, and a control step for controlling a reproduction process for the object data according to a determination result in the step of making a determination and the access point information.

Other objects, features and advantages of the invention will become apparent from the following detailed description taken in conjunction with the accompanying drawings.

### BRIEF DESCRIPTION OF THE DRAWINGS

FIG. 1 is a block diagram showing a structure of a MPEG-4 reproduction device in accordance with an embodiment of the present invention.

FIG. 2 is a block diagram showing an example of a structure of an IPMP control section 20 in FIG. 1.

FIG. 3 is a flow chart illustrating operations of the IPMP control section 20 shown in the FIG. 1.

FIG. 4 shows an example of IPMP information in accordance with an embodiment of the present invention.

FIG. 5 shows an example of region codes in accordance with an embodiment of the present invention.

FIG. 6 is a flow chart illustrating process steps of step 305 in the flow chart in FIG. 3.

FIG. 7 shows an example of access points in accordance with an embodiment of the present invention.

FIG. 8 shows an example of BIFS scripts in accordance with an embodiment of the present invention.

FIG. 9 shows another example of BIFS scripts in accordance with an embodiment of the present invention.

### DETAILED DESCRIPTION OF THE PREFERRED EMBODIMENTS

Preferred embodiments of the present invention will be described in detail below with reference to the accompanying drawings.

<Structure Of MPEG-4 Reproduction Device>

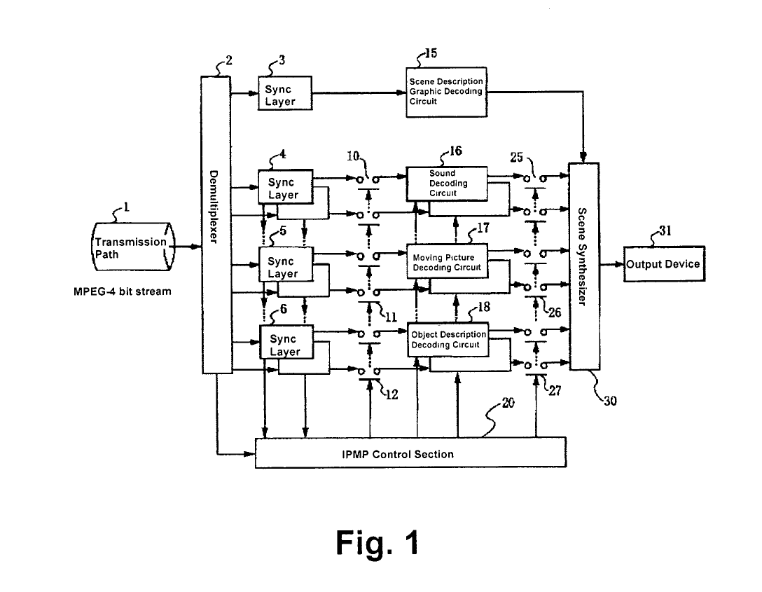

FIG. 1 is a block diagram showing a structure of a MPEG-4 reproduction device in accordance with a preferred embodiment of the present invention. In the figure, a data path 1 represents one of various networks through which a MPEG-4 bit stream is delivered. Noted that the data path 1 in the present embodiment not only indicates communication lines such as a broadcasting network and a communication network, but includes recording media themselves such as a DVD-RAM.

When the MPEG-4 reproduction device receives a MPEG-4 bit stream delivered from a network via the data path 1 or a MPEG-4 bit stream read from the recording medium via the data path 1, it first inputs the MPEG-4 bit stream into a demultiplexer 2.

At the demultiplexer 2, scene description data containing graphic data, sound object data (sound bit stream), moving picture object data (moving picture bit stream), and object description data are separated from the received MPEG-4 bit stream, and are input into synchronization layer processing circuits 3-6, respectively.

Here, the sound object data are, for example, data that are encoded with the high efficiency (compression) coding such as the Code Excited Linear Prediction (CELP) coding and the Transform domain Weighted Interleave Vector Quantization (TWINVQ) coding. The moving picture object data are data that are encoded with a high efficiency (compression) coding such as the commonly known MPEG-2 and H-263 methods. Also, the object description data contain, for example, animation or the like and are similarly encoded in a form appropriate to each of the description data.

The scene description data containing graphic data, the sound object, the moving picture object, and the object description data, which are synchronized at the synchronization layer processing circuits 3-6 according to time information called time stamp attached to the bit stream, are encoded with the high efficiency (compression) coding as described above, and therefore are decoded by decoding circuits 15-18 for each object, respectively.

Also, in the present embodiment, the MPEG-4 reproduction device can decode the MPEG-4 bit stream even when plural different types of objects are present in each of the sound object, the moving picture object, and the object description data. Therefore, the MPEG-4 reproduction device includes a plurality of synchronization layer processing circuits and a plurality of decoding circuits for each of the sound object, moving picture object, and object description data.

The sound object, the moving picture object, and the object description data decoded at the respective decoding circuits 16, 17, and 18 are supplied to a scene synthesizing device 30, and the scenes are reproduced according to the scene description information decoded at the decoding circuit 15.

A final multi-media data string thus obtained is supplied to an output device 31 such as display device, a speaker device and a printer, and replayed.

In the present embodiment, a received data stream (MPEG-4 bit stream) includes Intellectual Property Management and Protection (IPMP) information added to a bit stream because it may be necessary to control the reproduction of the data to protect the intellectual property for each of the objects composing scenes such as sounds and moving pictures.

In the apparatus in accordance with the present embodiment, the IPMP information is extracted by the demultiplexer 2, and is supplied to an IPMP control section 20. The IPMP control section 20, when necessary, shuts off any of objects at access points 10, 11 and 12, or 25, 26 and 27, or superposes an obstruction signal on any of objects, or decodes any of encrypted objects, or controls the reproduction of any of objects by accessing to the decoding circuits 16, 17 and 18, and stops the operations. By doing so, when a bit stream containing contents protected by the intellectual property is input, the reproduction of the bit stream can be prevented.

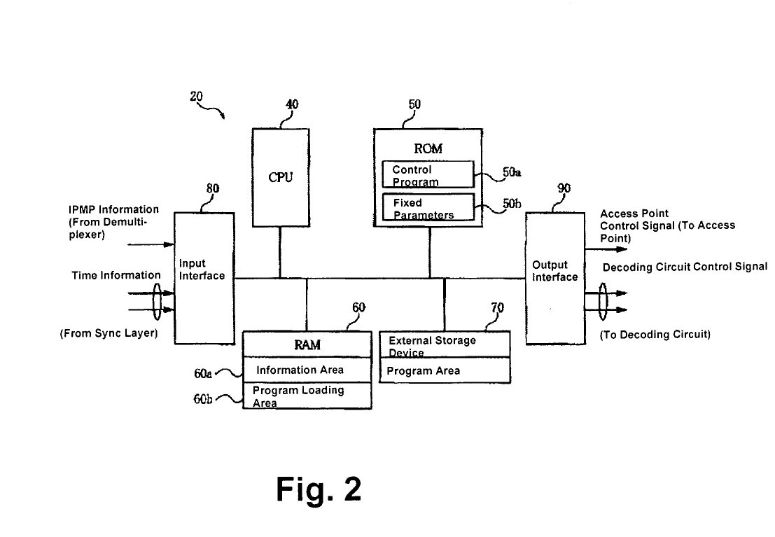

FIG. 2 is a block diagram showing an example of a structure of the IPMP control section 20 in FIG. 1. In FIG. 2, a CPU 40 controls the IPMP control section 20. A ROM 50 is a recording medium that stores a control program 50a which controls the IPMP control section 20 and fixed parameters 50b. A RAM 60 is a recording medium which the CPU 40 uses as a temporary storage medium and contains an information area 60a that stores IPMP information and a program loading area 60b for storing programs loaded from an external storage device 70.

The external storage device 70 may be composed of any appropriate storing device such as a floppy disk, a CD-ROM or the like, and stores programs that are to be loaded onto the program loading area 60b.

An input interface 80 inputs IPMP information from the demultiplexer 2 and the time information from the synchronization layers 4-6. An output interface 90 outputs access point control signals to the access points 10-12, and 25-27, and decoding circuit control signals to the decoding circuits 16-18.

In the present embodiment, the IPMP control section 20 is shown as an independent processor element. However, it is obvious that the CPU 40 may control all or part of the MPEG-4 reproduction device, or the function of the IPMP control section 20 can be implemented in part or in its entirety by software.

<Example of Operations of MPEG-4 Reproduction Device>

Operations of the MPEG-4 reproduction device in accordance with the present embodiment, particularly, operations of the MPEG-4 reproduction device when IPMP information is used, will be described in detail below.

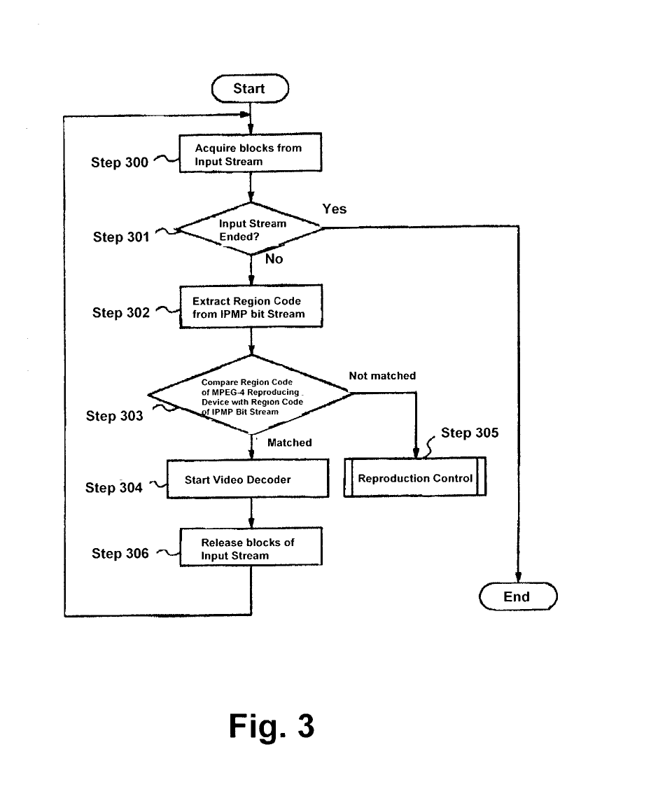

FIG. 3 is a flow chart of operations of the IPMP control section 20 performed when the MPEG-4 reproduction device receives a MPEG-4 bit stream. In this example, the MPEG-4 bit stream includes at least a bit stream containing objects of moving picture data and IPMP information containing a region code related to a region in which the moving picture data may be authorized to be reproduced.

In this case, the IPMP control section 20 specifies a region that is applied to the encoded moving picture bit stream which is separated by the demultiplexer 2 in step 300, and sets up one packet of data of the bit stream as Input Stream.

Next, in step 301, a determination is made as to whether or not the input stream has reached to the end of the bit stream. If it has reached the end of the bit stream, in other words, if the moving picture bit stream subject to the controls has reached to its end, the process is completed, and if not, the process proceeds to step 302.

In step 302, an area corresponding to the region code is specified and extracted from the IPMP bit stream that has been separated by the demultiplexer 2.

More specifically, a description is provided to specify the IPMP object type in the beginning of IPMP information, and has the following format according to the Final Draft of International Standard (FDIS) of MPEG-4 Part 1: Systems:

class IPMP_Descriptor ( ) extends BaseDescriptor: bit (8) IPMP_DescrTag {

bit stream (8) IPMP_Descriptor ID;
unsigned int (16) IPMPS_Type;
if (IPMPS_Type == 0) {

bit stream (8) URLString[sizeOflnstanc-3];

} else {

bit stream (8) IPMP_data [sizeOflnstance-3];

}

}

IPMPS_Type indicates the type of the IPMP control section 20, and when the IPMPS_Type is 0, information to protect and control the intellectual property is located in a place specified by URLString. IPMPS_Type which has a value other than 0 is registered in Registration Authority (RA), and information to protect and manage the intellectual property is described in IPMP_data, etc.

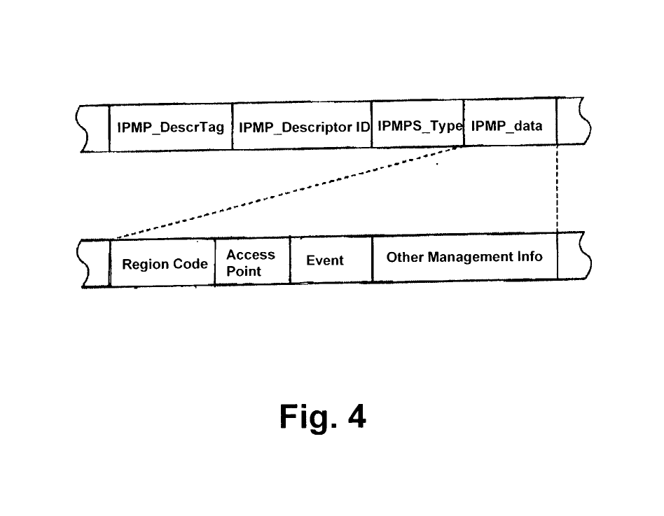

The IPMP control section 20 identifies the IPMPS_Type in the IPMP information, refers to URLStrings or IPMP_data, etc., and can determine a control method for an object which is subject to the protection and management. A syntax in this IPMP_data is not determined, and the IPMP_data consists of a region code section and other data sections in accordance with the present embodiment as shown in FIG. 4. Also, these region codes are determined by the copyright holder.

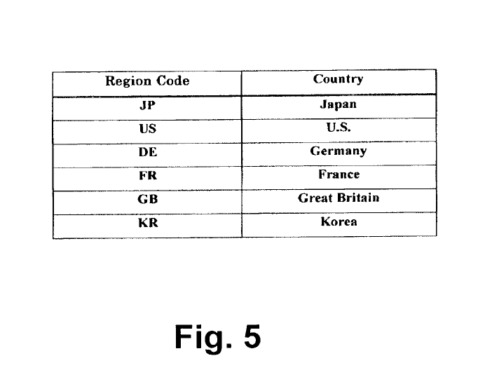

In this embodiment, the region code indicates the country name, and is expressed by a combination of two Roman characters as standardized by ISO 3166. In the example in FIG. 5, the region codes indicating Japan, U.S., Germany, France, U.K, and South Korea are expressed as JP, US, DE, FR, GB, and KR, respectively.

Also, numbers such as the country codes of telephone numbers can be used as the region codes. In addition, the region codes are not limited to the countries, but can designate a wider or narrower area. If the region code is encoded, the encoded region code may be decoded and then used.

The aforementioned region codes indicate countries which the copyright holder authorizes the decoding and reproduction of the moving picture data transmitted to the data path 1. Accordingly, in the example shown in FIG. 5, the decoding and reproduction of the data can be performed only in the six countries mentioned above. Also, if the decoding and reproduction are permitted in all regions or countries, special symbols such as “**” can be used for the region code.

In step 303, a determination is made as to whether or not the region code extracted from the IPMP bit stream in the previous step matches the region code of the MPEG-4 reproduction device. Whey they match, the process proceeds to step 304, and if not, the process proceeds to step 305 to control the decoding and reproduction of the moving pictures.

The region code of the MPEG-4 reproduction device can be stored inside the reproduction device and read from there. Alternatively, the region code can the one calculated from location information obtained from a measurement device such as a Global Positioning System (GPS) and a Personal Handy Phone (PHS).

In step 304, the moving picture decoding circuit 17 is started (or its operation is continued), and decode the moving picture bit stream.

In step 306, the packet of the Input Stream obtained at step 300 is released, and the process returns to step 300, and continues the execution.

It is noted that the information in the IPMP_data area is not limited to the region code, and can also be used by combining itself with various management information to control the system of the present invention. For example, restrictions over the use period for the object, limitations on users, limitations on access devices, and identification information such as a key to release scrambles can be implemented to perform other controls without departing from the essence of the present invention. Also, information for comparison which is necessary for determining if the reproduction of the data is permitted can be, for example, information characteristic to the reproduction device stored in the MPEG-4 reproduction device, the time read from a clock in the reproduction device, an input of a password that has been notified in advance only to proper users, and/or information obtained from a memory card such as Smart-card coupled to the MPEG-4 reproduction device.

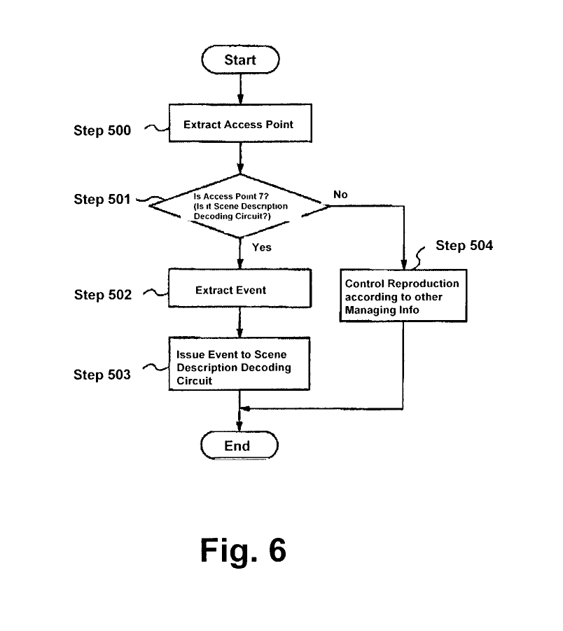

Furthermore, regarding the reproduction control method to be conducted in step 305, the IPMP control section 20 can determine according to the information in the IPMP_data area. The reproduction control operations in step 305 will be described in detail below with reference to the flow chart in FIG. 6.

In step 500 in FIG. 6, an access point is extracted from the access point designation section in the IPMP_data area. The access points are to specify positions at which the IPMP control section 20 controls the decoding and reproduction of the objects delivered to the data path 1. More specifically, it is necessary to point the preceding stage or succeeding stage of each of the decoding circuits 16, 17, and 18, in other words, the access points 10, 11 and 12, or 25, 26 and 27, or the decoding circuits 15, 16, 17 and 18.

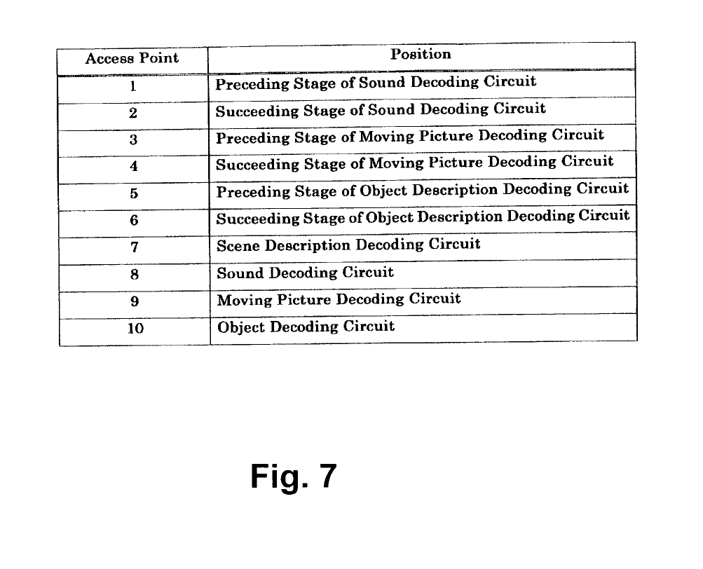

For example, as the access points in the example in FIG. 7, 1 is assigned to the preceding stage of the sound decoding circuit, 2 is to the succeeding stage of the sound decoding circuit, 3 is to the preceding stage of the moving picture decoding circuit, 4 is to the succeeding stage of the moving picture decoding circuit, 5 is to the preceding stage of the object description decoding circuit, 6 is to the succeeding stage of the object description decoding circuit, 7 is to the scene description decoding circuit, 8 is to the sound decoding circuit, 9 is to the moving picture decoding circuit, and 10 is to the object description decoding circuit.

In step 501, a determination is made as to whether or not the extracted access point is 7, in other words, whether or not the access point is assigned to the scene description decoding circuit 15.

If the access point is not the scene description decoding circuit 15, the IPMP control section 20 moves the process to step 504 to shut off bit streams at the specified access points, to superpose obstruction signals, to decode encrypted bit streams, and/or to stop the operations of the decoding circuits.

The IPMP control section 20 can determine which one of the control methods is to be employed at step 504 according to various control information as well as the aforementioned information.

In step 501, if the access point is 7 by which the scene description decoding circuit 15 is specified, the process is proceeded to step 502 to extract an event from the event designation section of the IPMP_data area.

In step 503, the event extracted in the previous step is issued for the designated access point or the scene description recover circuit 15. The scene description decoding circuit 15 which received the event is capable of changing scenes according to the BIFS script.

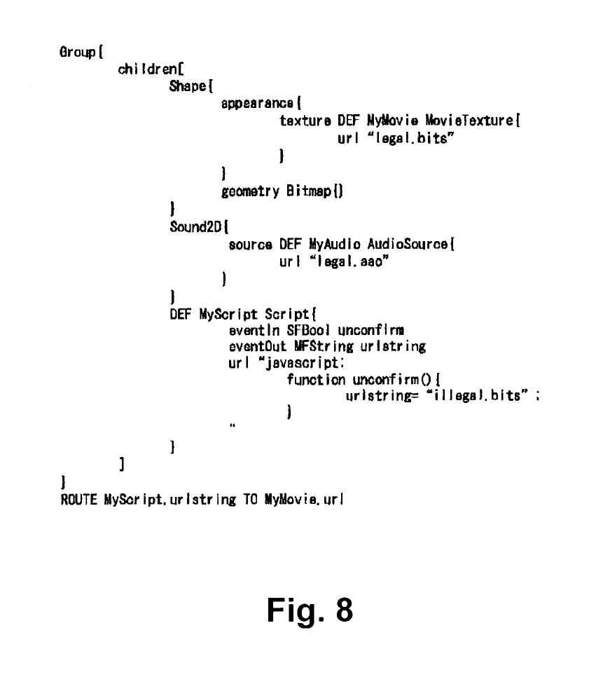

FIG. 8 is an example of a BIFS script describing scenes of the MPEG-4 bit stream containing moving pictures and sounds. The BIFS script is described in a manner that moving pictures can be switched when an authorization is not given.

A moving picture is defined by a MovieTexture node defined by the name MyMovie in the 5th row, and uses “legal.bits” described in the field url in the 6th row as moving picture data. The “legal.bits” is a bit stream of the MPEG-4 Video.

Similarly, a sound is defined by an AudioSource node defined by the name MyAudio in the 12th row, and uses “legal.aac” described in the field url in the 13th row as sound data. The “legal.aac” is a bit stream compressed by the MPEG-4 Advanced Audio Coding method.

Also, a Script node that is defined by the name MyScript in the 16th row can receive, process, and generate an event using eventIn, field and eventOut. In this embodiment, the BIFS script describes that, when an unconfirm event (the 17th row) is received, a function unconfirm ( ) described in JavaScript in the field url (the 19th-23rd row) is executed, and an unstring event (the 18th row) is generated.

The function unconfirm ( ) sets up moving picture data “illegal.bits” in the unstring. The “illegal bits” is a bit stream of the MPEG-4 Video when an authorization is not given.

And, by a BIFS command, ROUTE MyScript.urlstring TO MyMovie.url, in the end of the scene, the urlstrting event generated from the aforementioned MyScript is sent to the field url of the aforementioned moving picture MyMovie.

The copyright holder may set “7” in advance in the access point section of the IPMP_data area and “unconfirm” in the event section, and describes a BIFS script in a manner shown in FIG. 8. By doing so, when users are not authorized by management information other than that of the IPMP_data area, the IPMP control section 20 can issue an event “unconfirm” to the scene description decoding circuit 15, which can change the aforementioned moving picture from “legal.bits” to “illegal.bits.”

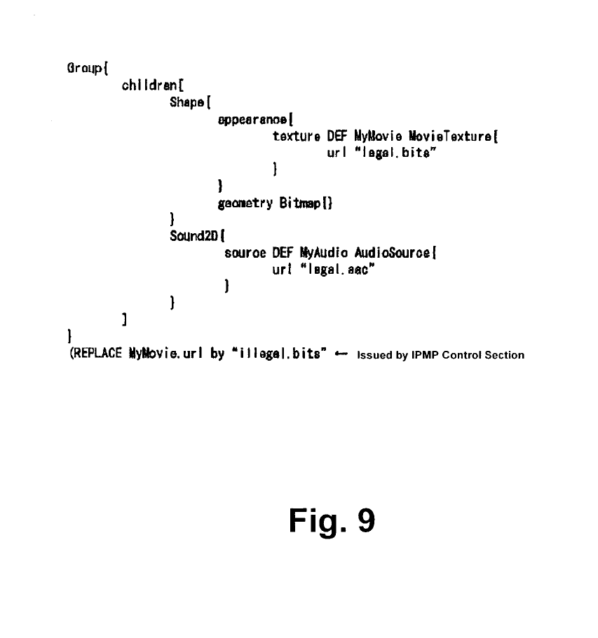

Also, the example in FIG. 8 has a structure in which, by writing a Script node and a ROUTE command in the BIFS script in advance, when the IPMP control section 20 issues an event to the scene description decoding circuit 15, the url of the MovieTexture node is changed, and the moving picture object is switched. However, BIFS scripts without a Script node and a ROUTE command can be used to achieve the effects and operations similar to those described above. Such a BIFS script is shown in FIG. 9.

In this example, the following command is specified in the event section of the IPMP area:

REPLACE MyMovie.url by “illegal.bits.”

The IPMP control section 20 which extracts the above command in step 502 sends the same to the scene description decoding circuit 15. Then, “legal.bits” specified in the field url of the moving picture object MyMovie is replaced with “illegal.bits” and moving pictures that will be reproduced can be switched.

In this embodiment, a MPEG-4 bit stream consists of a bit stream of moving picture data in units of packets and a bit stream of IPMP information related to the moving picture data. However, IPMP information can be attached not only to moving picture data but also to each object and sound datum composing the moving picture data. Accordingly, it is noted that not only moving pictures are subject to object switching controls, but also each object data and/or sound data which compose the moving picture data may be subject to object switching controls.

Accordingly, when decoding information from a data stream containing multiple object streams, the MPEG-4 reproduction device as an information processing device in accordance with the present embodiment, and its control method can control the decoding and reproduction by switching certain objects protected by the copyright to different objects.

Also, the present invention is applicable to a system consisting of multiple devices (for example, a host computer, an interface device, a reader, a printer and the like) as well as a device consisting of one equipment (for example, a VTR, a personal computer or the like).

Furthermore, the effects and operations of the embodiment described above are similarly achieved by providing a system or an apparatus with a recording medium that stores program codes of the software that achieves the functions described in the above embodiment, and having a computer (or CPU and MPU) of the system or the apparatus read and execute the program codes stored in the recording medium. In this case, the program codes read from the recording medium perform the aforementioned functions of the present embodiment, and therefore the recording medium that stores the program codes will compose the present invention.

As a recording medium to store the program codes, for example, a floppy disk, a hard disk, an optical disk, an optical magnetic disk, a CD-ROM, a CD-R, a magnetic tape, a non-volatile memory card, and a ROM can be used.

Also, it goes out saying that the aforementioned function of the present embodiment can be achieved not only by executing the program codes read by the computer, but also by having an operating system (OS) running on the computer perform all or part of the processing according to the program codes.

Furthermore, after the program codes read from the recording medium are written in a memory installed on a function expansion board inserted in the computer or in a memory installed in a function expansion unit that is connected to the computer, a CPU or the like installed on the function expansion board or the function expansion unit performs all or part of the processing according to the directions of the program codes. Such a structure also achieves the aforementioned functions of the present embodiment.

When the present invention is applied to the recording medium mentioned above, the recording medium stores program codes corresponding to the flow chart explained above. In other words, the program codes containing each module stored in the external storage device 70 of FIG. 2 are stored in the recording medium.

As is clear from the description above, in the embodiment example, when reproducing data from a bit stream containing single or multiple encoded object data, the reproduction process can be controlled by region for each of the object data.

Also, in accordance with the present embodiment, when reproducing each object data from a bit stream containing single or multiple encoded object data, the data reproduction control for object data desired can be executed from the supply side of the data stream based on determinations as to whether or not the reproduction of the object data is permitted. As such, the intellectual properties can be protected in a more flexible fashion.

In other words, the foregoing descriptions of embodiments has been given for illustrative purposes only and not to be construed as imposing any limitation in every respect.

The scope of the invention is, therefore, to be determined solely by the following claims and not limited by the text of the specifications and alterations made within a scope equivalent to the scope of the claims fall within the true spirit and scope of the invention.

What is claimed is:

1. A data processing apparatus that receives a bit stream containing one or a plurality of encoded object data for objects and managing information that manages the object data, and decodes the encoded object data by each of the objects, the data processing apparatus comprising:
an extraction device that extracts a first region code indicative of a region with respect to the object data included in the managing information;
an acquisition device that acquires a second region code indicative of a region with respect to the data processing apparatus; and
a control device that controls a reproduction process for the object data according to the first region code and the second region code.

2. A data processing apparatus according to claim 1, wherein the bit stream is a MPEG-4 bit stream.

3. A data processing apparatus according to claim 2, wherein the managing information is IPMP information.

4. A data processing apparatus according to claim 1, wherein the first region code and the second region code are codes expressing countries, respectively.

5. A data processing apparatus according to claim 1, wherein the acquisition device comprises a memory that stores the second region code in the data processing apparatus.

6. A data processing apparatus according to claim 1, wherein the acquisition device calculates the second region code based on positional information measured by a GPS or a PHS.

7. A data processing apparatus according to claim 1, wherein the acquisition device makes a determination as to whether or not reproduction of at least one of the object data subject to the determination is permitted by the first region code and the second region code, and controls an input of the least one of the object data subject to the determination in a specified reproducing device for reproducing the least one of the object data subject to the determination, a reproduction process for the least one of the object data, and a reproduction and output of the least one of the object data.

8. A data processing method that receives a bit stream containing one or a plurality of encoded object data for objects and managing information that manages the object data, and decodes the encoded object data by each of the objects, the data processing method comprising the steps of:
extracting a first region code indicative of a region with respect to the object data included in the managing information;
acquiring a second region code indicative of a region with respect to the data processing apparatus; and
controlling a reproduction process for the object data according to the first region code and the second region code.

9. A computer-readable recording medium that stores program codes to achieve functions of a data processing apparatus that receives a bit stream containing one or a plurality of encoded object data for objects and managing information that manages the object data, and decodes the encoded object data by each of the objects, the program codes comprising:
codes for an extraction step for extracting a first region code indicative of a region with respect to the object data included in the managing information;
codes for an acquisition step for acquiring a second region code indicative of a region with respect to the data processing apparatus; and
codes for a controlling step for controlling a reproduction process for the object data according to the first region code and the second region code.

10. A data processing program comprising steps to achieve functions of a data processing apparatus that receives a bit stream containing one or a plurality of encoded object data for objects and managing information that manages the object data, and decodes the encoded object data by each of the objects, the data processing program comprising:
an extraction step for extracting a first region code indicative of a region with respect to the object data included in the managing information;
an acquisition step for acquiring a second region code indicative of a region with respect to the data processing apparatus; and
a controlling step for controlling a reproduction process for the object data according to the first region code and the second region code.

11. A data processing apparatus that receives a bit stream containing one or a plurality of encoded object data for objects and managing information that manages the object data, and decodes the encoded object data by each of the objects, the data processing apparatus comprising:
a determination device that makes a determination as to whether or not a reproduction of the object data is permitted based on the managing information;
an extraction device that extracts event information from the managing information for changing the object data to another data; and
a control device that controls a reproduction process for the object data according to an output of the determination device and the event information.

12. A data processing apparatus according to claim 11, wherein the managing information includes access point information indicative of positions at which the reproduction process for the object data is controlled, and the control device controls the reproduction process for the object data according to the access point information.

13. A data processing apparatus according to claim 11, wherein the positions at which the reproduction process for the object data is controlled are at a point where the object data is input in a reproduction device, at a point where the object data is processed by the reproduction device, and a point where the object data is output from the reproduction device.

14. A data processing apparatus according to claim 11, wherein the bit stream includes scene description data that defines spatial and chronological dispositions of each object, and the control device controls the reproduction process for the object data by changing the scene description data.

15. A data processing apparatus according to claim 11, wherein the bit stream is a MPEG-4 bit stream.

16. A data processing apparatus according to claim 11, wherein the managing information is IPMP information.

17. A data processing method that receives a bit stream containing one or a plurality of encoded object data for objects and managing information that manages the object data, and decodes the encoded object data by each of the objects, the data processing method comprising the steps of:
making a determination as to whether or not a reproduction of the object data is permitted based on the managing information;
extracting event information from the managing information for changing the object data to another data; and
controlling a reproduction process for the object data according to an output of the determination device and the event information.

18. A computer-readable recording medium that stores program codes to achieve functions of a data processing apparatus that receives a bit stream containing one or a plurality of encoded object data for objects and managing information that manages the object data, and decodes the encoded object data by each of the objects, the program codes comprising:
codes for a determination step for making a determination as to whether or not a reproduction of the object data is permitted based on the managing information;
codes for an extraction step for extracting event information from the managing information for changing the object data to another data; and
codes for a control step for controlling a reproduction process for the object data according to an output of the determination device and the event information.

19. A data processing program comprising steps to achieve functions of a data processing apparatus that receives a bit stream containing one or a plurality of encoded object data for objects and managing information that manages the object data, and decodes the encoded object data by each of the objects, the data processing program comprising:
a determination step for making a determination as to whether or not a reproduction of the object data is permitted based on the managing information;
an extraction step for extracting event information from the managing information for changing the object data to another data; and
a control step for controlling the reproduction process for the object data according to an output of the determination device and the event information.

20. A data processing apparatus that receives a bit stream containing one or a plurality of encoded object data for objects and managing information that manages the object data, and decodes the encoded object data by each of the objects, the data processing apparatus comprising:
a determination device that makes a determination as to whether or not a reproduction of the object data is permitted based on the managing information;
an extraction device that extracts access point information from the managing information, the access point information indicative of at least one position at which the reproduction process is controlled; and
a control device that controls a reproduction process for the object data according to an output of the determination device and the access point information.

21. A data processing apparatus according to claim 20, wherein the bit stream is a MPEG-4 bit stream.

22. A data processing apparatus according to claim 20, wherein the managing information is IPMP information.

23. A data processing method that receives a bit stream containing one or a plurality of encoded object data for objects and managing information that manages the object data, and decodes the encoded object data by each of the objects, the data processing method comprising the steps of:
making a determination as to whether or not a reproduction of the object data is permitted based on the managing information;
extracting access point information from the managing information, the access point information indicative of at least one position at which the reproduction process is controlled; and
controlling a reproduction process for the object data according to a determination result in the step of making a determination and the access point information.

24. A computer-readable recording medium that stores program codes to achieve functions of a data processing apparatus that receives a bit stream containing one or a plurality of encoded object data for objects and managing information that manages the object data, and decodes the encoded object data by each of the objects, the program codes comprising:
codes for a determination step for making a determination as to whether or not a reproduction of the object data is permitted based on the managing information;
codes for an extraction step for extracting access point information from the managing information, the access point information indicative of at least one position at which the reproduction process is controlled; and
codes for a control step for controlling a reproduction process for the object data according to a determination result in the step of making a determination and the access point information.

25. A data processing program comprising steps to achieve functions of a data processing apparatus that receives a bit stream containing one or a plurality of encoded object data for objects and managing information that manages the object data, and decodes the encoded object data by each of the objects, the data processing program comprising the steps of:
a determination step for making a determination as to whether or not a reproduction of the object data is permitted based on the managing information;
an extraction step for extracting access point information from the managing information, the access point information indicative of at least one position at which the reproduction process is controlled; and
a control step for controlling a reproduction process for the object data according to a determination result in the step of making a determination and the access point information.
